(19) United States
(12) Patent Application Publication
(10) Pub. No.: US 2010/0183931 A1
(43) Pub. Date: Jul. 22, 2010

(54) On board hydrogen producing fuel cell technology(elements) coil and plate system used separately or in combination to disassociate (fracture) water into its base components of hydrogen and oxygen by use of electrolytic fission to augment (boost) and or fuel an internal combustion (gas or diesel) engines while lessening emission pollutants

(76) Inventor: Keith Olin Hedman, Mountain House, CA (US)

Correspondence Address: Keith Olin Hedman, 785 Shelli Street, Mountain House, CA, 95391, US

(21) Appl. No.: 12/462,907

(22) Filed: Aug. 10, 2009

Related U.S. Application Data
(60) Provisional application No. 61/188,353, filed on Aug. 8, 2008.

(51) Int. Cl. H01M 8/22; H01M 8/04

(52) U.S. Cl. 429/428; 429/505

(57) ABSTRACT

A hydrogen fuel cell, producing hydrogen on demand using aqueous solutions containing de-ionized water and a buffer. This fuel cell technology works using either a plate and or coil cell technology, with or without modern day electronics like a Pulse Width Modulator, and or Coil Balancing Technology. The plates in these systems are solely dependent on the surface area and charge difference for Hydrogen gas production as well as additive concentration of buffer reagent in the cell. The cell or reactor core elements can be made using overlapping coils with a spacer layer or alternating plate arrays using spacers also, or many other shapes or dimensions and sizes just as long as you have alternating plates that provides reaction zones. This system demonstrates that hydrogen fuel can be produced and used to catalyze fuel in an internal combustion engine to increase full fuel burn while lessening pollutants. The purpose here was to construct a hydrogen cell that could accommodate either a plate based cell or a coiled based cell to produce Hydrogen gas on demand using a buffer reactor mixture and de-ionized water as the feed stock. We have tested these elements, both this new coil structure and the new plate structure and find that both of these designs are more productive then traditional plate cells since they are a more thought out design. These systems also can integrate neutral plates to fine tune the cell, however we did not find much of a benefit adding neutral plates in our experimentation. We have accomplished many of our goals with these new coil and plate technology systems, one which was to increase hydrogen gas production while packaging size of the apparatus was decreased. These elements are considerably more versatile and can be adjusted to provide custom sizes for custom applications of this technology with or without using Pulse Width Modulation or Coil Balancing electronics with predictable results. We also have perfected separating the gas molecules with another apparatus, and have experimented with a system to store amounts of the hydrogen gas that can be used on demand for future applications. The produced hydrogen gas can be pumped down into a gas cylinder for storage and future use. We have also experimented with adding more then one alternator and charging system into our test vehicle, this seems to be beneficial as well. Overall it looks like this technology offers a lot of benefit to yielding more power from fossil fuel, or from renewable forms of energy like ethanol or diesel fuel. We have also looked at harnessing kinetic motion of the vehicle while using hydrogen, all of these will lessen the negative effects that burning fossil fuel has on the environment and its inhabitants.

### REFERENCES CITED

| | | | |
|---|---|---|---|
| 1,219,333 | March 1917 | Kynaston | 204/149 |
| 1,262,034 | April 1918 | Frazer | 204/149 |
| 1,376,207 | April 1921 | Jacobs | 204/265 |
| 1,431,047 | October 1922 | Ruben | 204/265 |
| 1,544,052 | June 1925 | Avery | 204/149 |
| 1,862,663 | June 1932 | Curtis | 204/288 |
| 2,000,815 | May 1935 | Berl | 204/265 |
| 3,192,138 | June 1965 | Enk | 204/246 |
| 3,433,729 | March 1969 | Proskuryakov | 204/129 |
| 3,518,036 | June 1970 | Staats | 204/129 |
| 4,014,777 | March 1977 | Brown | 204/228.5 |

### FIELD OF INVENTION

This invention relates to hydrogen fuel cell technology, specifically the technology involved with the elements that are used to produce hydrogen for either boosting or fueling an internal combustion engine. In the USA and other developed countries, the increasing cost of fuel advances technologies to develop integrated systems to lower the cost of usage of fossil fuel, as well as lowering our dependence on foreign oil. This technology works on demand and does not store large amounts of explosive gas. The fuel byproducts of combustion are also less toxic that are produced when using this system in combination with normal internal combustion engines that don't have waste sparks. The system integrates an alternative source of energy that can be produced from the most abundant material on earth; water, it is presented to provide a scalable system using an electrolytic catalyst method to fracture water into a combustible fuel enhancing additive. This system can also be scaled to produce enough hydrogen to fuel an internal combustion engine. In this patent our circuit design is similar in some cases to that of Stanley Myers circuit, how it deals with resonant pulse frequency to split water into its respective components of Hydrogen and Oxygen to catalyze fossil fuel, however there are fundamental differences in the process used in this invention.

### BACKGROUND OF INVENTION

Our reactor elements are different in that we use, Pulse Width Modulation instead of an electronic injection system to separate the water molecules. Harmonic coil balancing technology can also be used for this hydrogen application. We feel that this field needs to be further developed to scale and refine water into a fuel on demand. Other technologies like continuous plasma discharge or plasma reformation need to be further explored as well.

The US Department of Energy estimates that over 110 tons of hydrogen need to be refined daily to substitute the over 200 million gallons of fossil fuel that are consumed daily. We see this technology as a transition step before fuel cell powered electric vehicles can be produced safely, economically and affordably. We feel that the goal of fuel cell powered electric vehicles to still be 15-25 years away due to research that is needed in battery technology, power inverter technology, DC Storage technology, and efficient AC motor technology.

### DESCRIPTION OF PREVIOUS ART

This patent has some very similar factors to Stanley Meyers Canadian Patent # 2,067,735 in that some of the circuits used in the process of producing the Hydrogen gas are similar. The vessel on our unit is very similar to Charles H. Frazer's patent # 1,262,034, the “hydroxy generator patent that was patented Apr. 9, 1918. However the cells elements in our two have fundamental enhancements that make them unique and different, because of these differences our cells are much more efficient and produce much more usable hydrogen gas on demand. We have used more advanced materials and tooling to produce a more complex product which has increased the efficiency of the devices, and has also allowed us to package the device differently. We also have the ability to use some similar advanced electronics that Stanley Meyers used in his Canadian Patent # 2,067,735 to further refine the hydrogen processing.

No other patents on record showed the two elements that we have produced as marketable products. Our coil and special plate design have not been produced to this date. It should be noted that several of these devices can be used in combination to produce enough hydrogen on demand from water to fuel a vehicle, about 9 liters per minute production to fuel a 1600 cc to 1800 cc engine; and about 27-37 liters of gas per minute production to fuel a V8 engine of 4.0 L to 7.2 L displacement, our goal with this system is to augment current fossil fuel vehicles with this system to lessen our nations demand on foreign oil.

### OBJECTS OF THE INVENTION

The primary object of the invention is to provide an apparatus that produces hydrogen on demand to aid in the catalysis of fossil fuel for an internal combustion engine. In this hydrogen fuel cell, electrolytic fission is being used to produce hydrogen fuel that is originating from the decomposition of water. There are two element or reactor designs proposed, one is a coil based system while the other is a alternating plate design.

A second primary object of the invention is to use this system in an integrated system that combines the two elements in combination with custom power supply devices like coil balancing and pulse width modulation, gas separation, and gas storage systems. These critical differences are what can aid in cleaning up the environment, producing less toxic emissions.

A main object of the invention is to show that production of hydrogen on demand is both attainable and feasible. Also storing small amounts of the purified version of Hydrogen is also possible. Another object of the invention is to provide a method and means to capture the unreacted Oxygen.

It is a further object of the invention to provide a means to use micro-processor control sequences to effect start, run and shut down operational modes.

It is still a further object of the invention to provide a means and method to achieve microprocessor control of charging batteries that run the vehicle operation and that of the fuel cell(s) during operation.

It is also an object of the invention to provide a means to provide safety features and manual overrides in the case of system failure.

The invention, two new improved hydrogen element technologies (types) are improved versions compared to what is currently available.

These models are highly productive in producing hydrogen gas. We have not found these designs out in production or in the literature and have been working on these model types for a few years. We are now ready to commercialize the product.

Both of these types of Hydrogen Producing Plate systems (Alternating Plate, and Coil) can be produced in varying sizes both plate height and width or length in case of the coil. Both use Stainless steel contacts and a polymer or non-conductive material to separate the plate arrays. Across the gap that is established is the electrical synapse where an electrical field is established and the current jumps here like a switch on and off like nano-discharge electrical strikes that form Hydrogen and Oxygen gas from Water containing a buffer solution to establish a current flow. The buffer strength (Molar Concentration or Ionic Strength) can be varied to fine tune the cell. The cell can be charged with either raw current of pulse width modulated current this current can also be transformed into high voltage electricity. Multiple coils can be used to charge the buffer immersed elements. When the Hydrogen and Oxygen is produced it is them pushed through the bubbler that is the first safety mechanism to transfer the on demand produced hydrogen derived from water. The bubbler then goes through a flash suppressor which is the second safety mechanism in the fuel line from the hydrogen fuel cell. If this is a booster cell that can also be used in diesel engines to scrub pollutants and to extend mileage ranges, or in an Internal Combustion Engine to either augment to extend fossil fuel mileage or the fuel Hydrogen can be pumped down using a compressor pump to pump down the hydrogen into a cylinder or dryer canister to fuel a compressed gas carburetor like those manufactured by IMPCO Manufacturing company. The compressed hydrogen fuel is then sprayed into the intake to fuel the engine. The fuel delivery mechanism will also be able to jet a small amount of fuel hydrogen to maintain an idle. Due to hydrogen's increased flammability the more hydrogen that is introduced into the engine is linearly proportional to the adjustment that must be made in the vehicles timing of spark. Standard vehicles are set at a timing spark initiation of a few degrees left of top dead center of an engines operation in its four or two stroke cycle.

The more hydrogen that is used (introduced) in to the engine as fuel, the more right of top dead center the ignition timing adjustment needs to be moved. This adjustment can be adjusted either mechanically or through the use of a timing circuit on newer vehicle models.

### SUMMARY OF INVENTION

In operation one would use one of these two versions of the device or both to produce Hydrogen gas to either boost or scalable with multiple cells and a vacuum pump and canister and vaporizer carburetor to fuel and run a vehicle. This device is desirable because of the heightened cost of energy at this current time, and because it does not pollute the environment like gasoline or diesel fuel that emits toxins and carcinogens. These devices can even be used to clean up emissions on currently operating vehicles while enhancing their yield of miles per gallon of fuel. We can provide a device that lasts several years that has better then a 6 month return on investment. In most cases with the use of an electronic device to fine tune the MAP of Mass Air Flow Sensor and Oxygen sensor(s) and an adequate Pulse Width Modulator, this device can increase fuel efficiencies by 25% or greater when used in combination with other fuel saving technologies that will be not be aforementioned in this PPL.

Both FIG. 1 and FIG. 3, it shows two distinct different technologies for fuel cell elements that can with use of either direct current or a Pulse Width Modulator yield high amounts of hydrogen gas to be used as fuel by an internal combustion engine. Both have been produced as prototypes and have been tested and continue to be tested for a better understanding of their longevity in the field. This unit starts with either a coil based hydrogen producing element or an alternating plate cell hydrogen producing element and a vessel to contain it. The Element is immersed in a solution of demonized water with a buffer added to it. The buffer can consist of many different substances and it is one of the factors that can be used to fine tune this device once it is into production. For all intense purposed it is possible to use buffers containing a system based on NACL, Sodium Carbonate, Phosphate Buffer, Sea Water, NaOH, KOH, and many other compounds that can transfer a charge across the electrolysis plates. The molar concentration of the buffer and the ionic strength are very much dependent on the type of cell and the electronics that are used to produce the electronic gradient of step gradient across the plates in the fuel cells.

Once the Hydrogen and Oxygen gas is produced in the vessel with the element(s) the gasses are then forwarded to the bubbler which acts as a check valve and an airlock system to forward large amounts of hydrogen gas safely through the system. Before the gas passes though into the intake it also passes through a flash suppressor that will extinguish any flash back of hydrogen. The flash back arrestor acts like a check valve in that it allows hydrogen on oxygen to go forward, but not backward, back to the fuel cell this only allows minimal amounts of hydrogen in specific parts of the system as a safety measure.

After the flash suppressor the gas is then introduced into the intake of the engine where it then either augments or fuels the engine depending on the concentration of the hydrogen and oxygen gas produced. These devices are utilized with electronics to mitigate the computer systems due to the carryover of Oxygen into these systems. The higher the amount of Hydrogen Fuel used the more the TDC on the motor needs to be moved to the right due to the increased flammability of the hydrogen running fuel.

### DESCRIPTION OF DRAWINGS

As seen in FIG. 4 or 5 it can be either a plate based system or a coil based system both using inert (non-conductive) spacers as structural components of the cells. For our purposes we have chosen to use 316 Stainless Steel for the plate systems, any stable stainless steel or brass type metals (alloys that are alkali stable) can be used. We found that 316 stainless has provided us with a very chemically resistant material that is easy to maintain.

In both FIGS. 4 and 5 we are using a plastic enclosure that holds a reservoir of buffer and de-ionized water for the electrolytic fission reaction to take place, either plate system is totally submerged in this reservoir. Both systems have a series of alternating positive and negative plates where the electrolytic fission takes place (between the plates). Electrolytic fission, electromagnetically breaks the strong covalent bonds of water or other aqueous solutions containing hydrogen to liberate hydrogen as a gas resulting in a fuel on-demand system, ideally from a non-flammable substance.

FIG. 4. also shows a check valve tube 8. that allows for a unidirectional flow of air to be pumped into the fuel cell expelling more gas by displacement. FIG. 4. also shows an auto fill device 2. that is used to keep the fuel cell full of its feed stock. In FIG. 4. the alternating plate system can be seen as 10, with the electrical contacts being 11 & 12, both (−) and (+) respectively. The plates in FIG. 4 are trimmed on one corner 9. so we could configure them as alternating with the use of metal hardware that would connect them as an electrode as seen as 3. The alternating plates were separated by (nylon or another non conductive material) spacers as seen as 13. A special anti-splash cap was constructed 6, and can be seen on the top of the vessel. The device was also constructed with safety in mind with the use of a rubber blow off cap 5. FIG. 5. uses the same principles and apparatus to generate hydrogen gas, however it is a coil structure separated by polymer insulators. Any non-chemically reactive metal can be used such as brass or stainless steel for either structures. FIG. 5 number 11 shows one of the polymer sheets that are used in this elements creation, number 10 shows one of the sheets of flexible metal that is used to transfer the electrical charge. In FIG. 5. numbers (7&8) show both positive and negative contacts that provide power to the cell. FIG. 5. number 1 shows a check valve that includes a tube to pump in a displacement of air to help in moving Hydrogen from the fuel cell into the engine. FIG. 5. also has a splash proof outlet fitting 5, and has a blow off rubber safety cap as seen as number 4, and a fastening device for the rubber safety cap as seen as number 3.

FIG. 6. shows the reaction space where the electrolytic fission takes place 11. The charge builds up on the surface of the electrolysis plates as seen by 7 and 8. The species are then subjected to very strong electromagnetic forces as seen in 6 FIG. 6. The result is fracturing of the covalent bonds that hold the water molecule together as seen in 4&5 FIG. 6. This all happens between the resulting surface areas that are alternating in charge (10 & 9). In this system FIG. 6 shows both positive 3 and 2 negative contacts that separate the molecules.

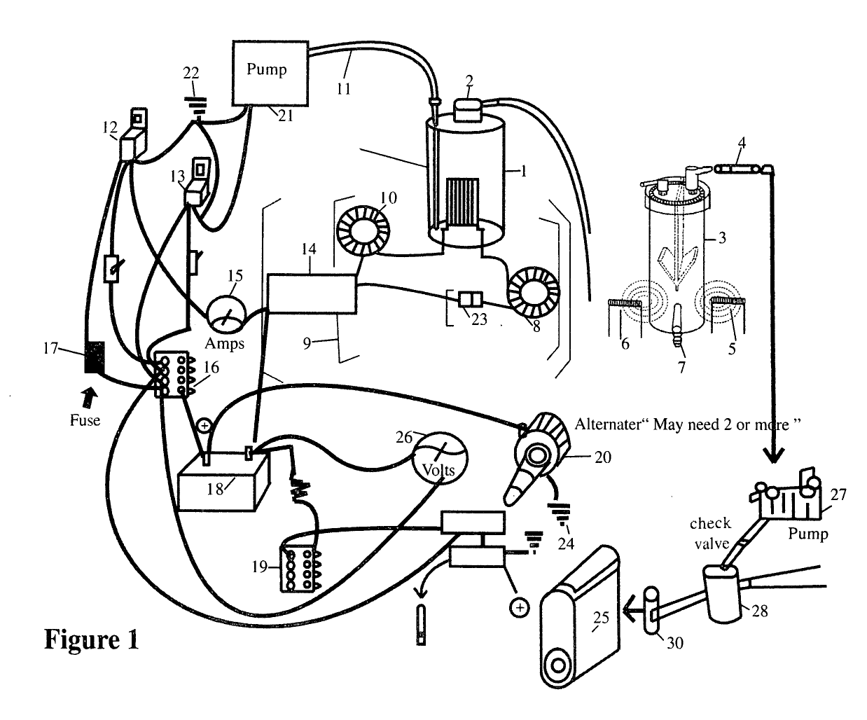

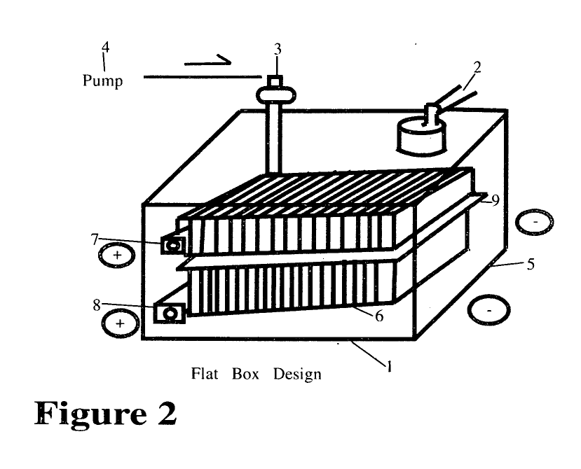

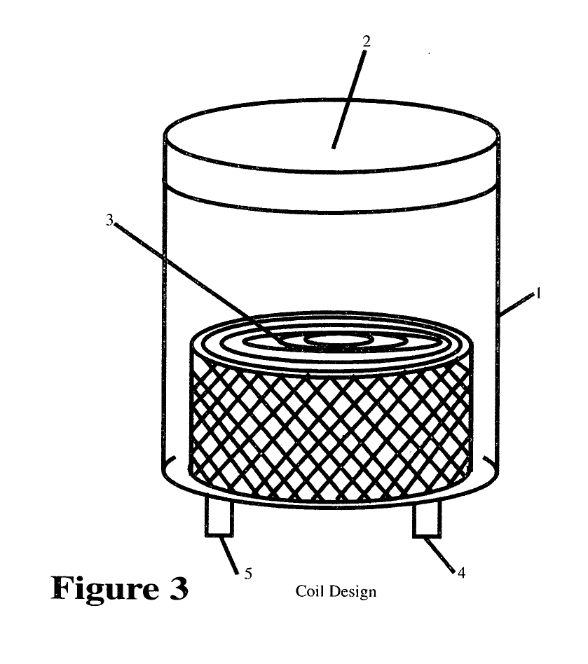

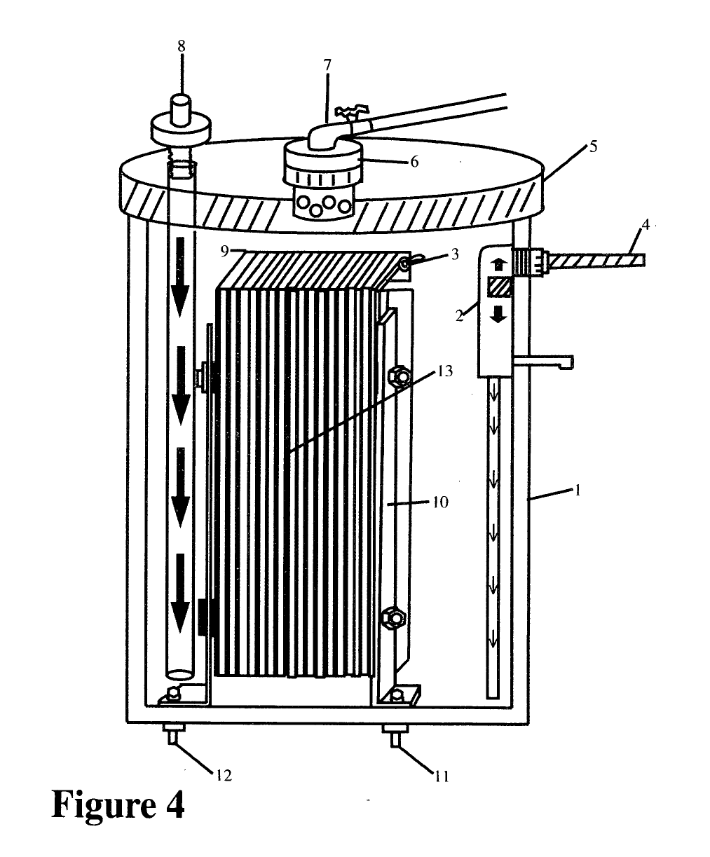

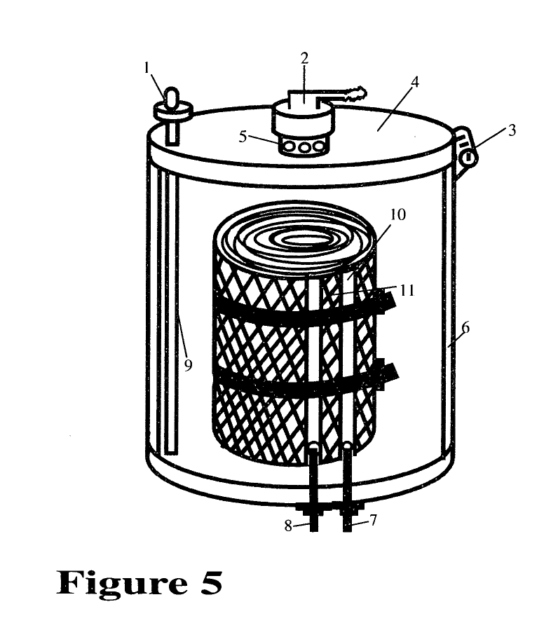

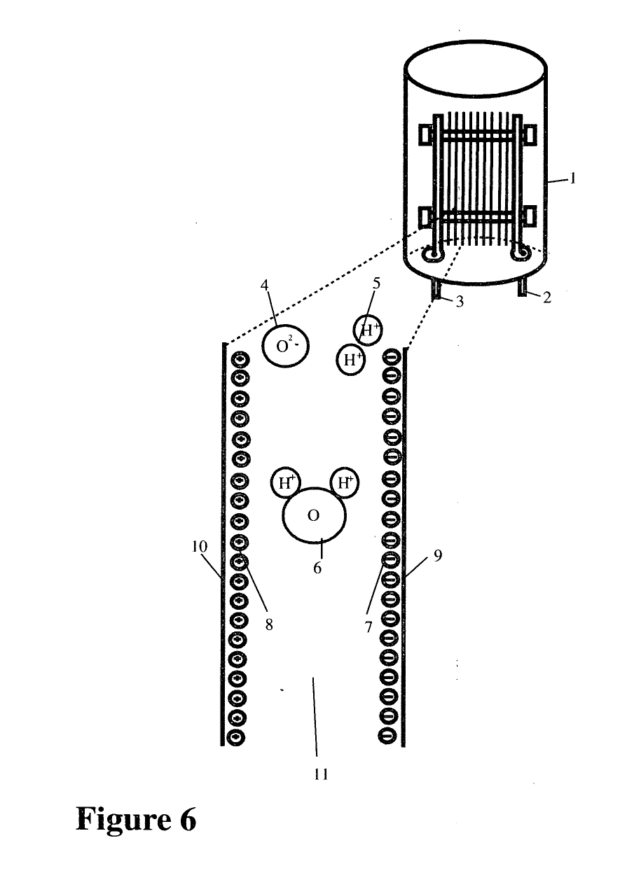

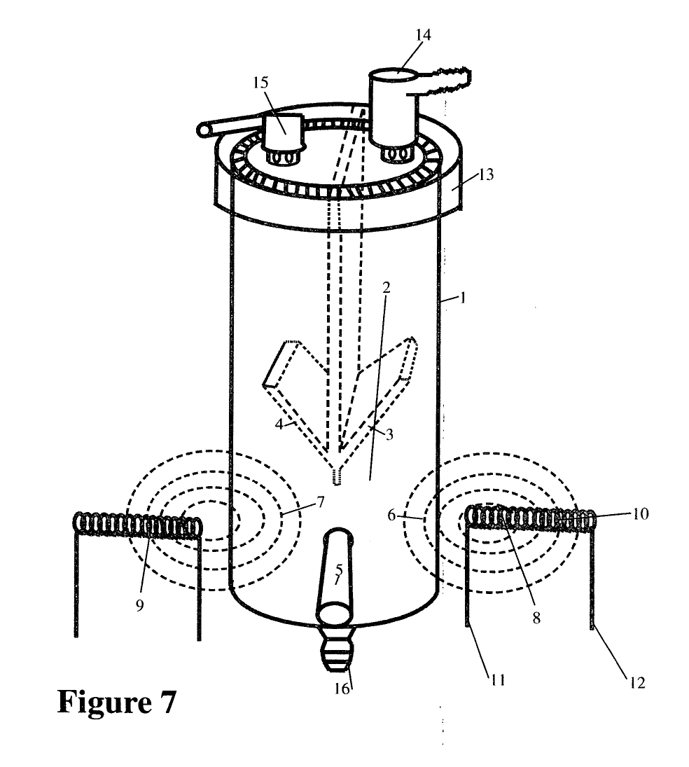

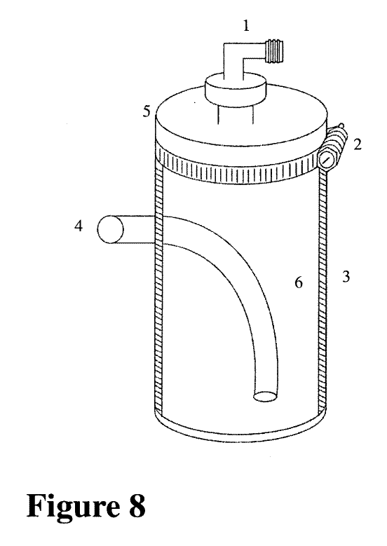

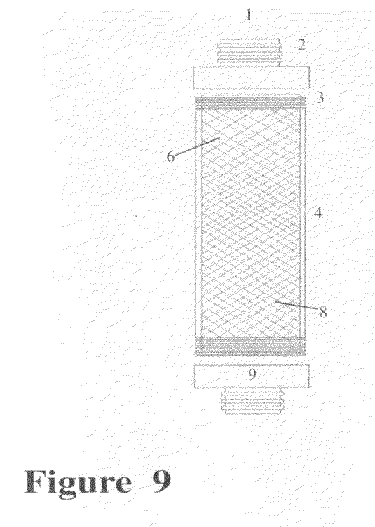

In FIG. 6 the water molecule number 6 experiences electromagnetic forces that cause the covalent bond of water to elongate and collapse this reaction is endothermic. The energy needed for dissociation or decomposition into atomic Hydrogen and atomic Oxygen is 135 kcal/mol. This amount is equivalent to about 5.9 eV's. The result in FIG. 6 is number 4 one atom of Oxygen and two atoms of Hydrogen. Both atomic constituents are attracted to their respective opposite plate and once a critical point is reached the molecule snaps apart yielding only gas molecules.

The next stage in the fuel processing is to refine the mixture by separating the fuel in to its atomic constituents or not. Both FIGS. 7 and 8 show the next mechanism(s) in the process. FIG. 7. is a chemical gas bubbler and separator combination with an anti flash back bubbler device, where as FIG. 8 is just an anti-flash back safety bubbler device. FIG. 8 has a resulting transfer tube from the plate cell reactor as demarcated by 4 on FIG. 8. As on the fuel cell itself FIG. 8 safety bubbler has a rubber safety blow off cap that is fastened with a large stainless steel clamp seen as numbers 5 and 2, the bubbler apparatus being number 6. FIG. 8 also has the same anti splash cap barbed hose fitting as on both reactor fuel cells as seen by number 1. FIG. 8, 3 is filled with de-ionized water and a special charging reaction mixture. The devices body can be made of stainless steel, brass or can be made out of polymer or stainless.

FIG. 7. shows a fuel separator. It uses electromagnetic coils and plates to separate both positive and negative charges to separate oxygen that carries a negative 2 charge and Hydrogen that carries a positive 1 charge. In FIG. 7. There is a non-permeable barrier as denotated by 4 & 3, that in combination with the electromagnetic coils 9 and 8 separates the gas to the resulting sides and resulting outlets 15 and 14. The gas is first bubbled up from the fuel reactor through a porous plastic tube as demarcated by number 5, through an in-port 16, in FIG. 7. Once the gas has bubbled out through the in-port 16 and the porous plastic tube the electromagnetic coils 9 and 8 create corresponding electromagnetic fields to separate both Oxygen and Hydrogen atoms, which as a gas them bubble through the buffer in figure to either side of the gas separator. This separator device also has a safety blow off cap 13, and is filled with non-reactive inert de-ionized water 2, however to increase the electromagnetic force we have added a mild buffer 6, and 7. So the electromagnetic fields that are created by coils 9 and 8 cause Oxygen with a charge of negative two, to go to one side while Hydrogen that has a positive one charge goes to the opposite side. Both can be utilized by the engine, our main interest here is Hydrogen, and it is then ported out of either FIG. 8 or FIG. 7 for the next process.

Last stage before introduction of hydrogen into the engine, is into system which then pumps hydrogen down to store or for direct injection via our safety flash suppressor unit or FIG. 9. This unit FIG. 9, is a tube made out of either polymer or metal 4, and is packed with very coarse stainless steel mesh or wadding 6 or 8.

This unit is reversible and has two very large frits that help retain the packing material that are located in each endcap 3 or 9. The unit then has two barbed ends on it so hoses can be fastened to this anti-flash back unit on ends 2 and 9. This unit stops any trace or flash back from the engine. It accomplices this by localizing the flash back inside the suppressor and by reducing volumes by a loosely packed honeycomb matrix of the flash back suppressor. When an explosion happens it is immobilized by the matrix of the flash back suppressor.

FIG. 1 shows how this unit is dynamically connected together. The reactor cell in FIG. 1 number 1, can be either plate or coil based, it can also be hooked up with a coil balancing system and diode 9 which is made up of coils numbers 10, 8, and diode number 23. This system can also be used in combination with a pulse width modulator 1, or without. These devices also can be successfully run directly off the battery 18, with a fuse 17, in line and via a relay 12 or 13. The next stage is to move the gas to either the bubbler or the bubbler separator that would replace number 3 with FIG. 8, and FIG. 9. The gas in FIG. 1, can then be pumped down once separated from oxygen, the hydrogen containment as demarcated in pathway 4. If pathway 4 is not used the bubbler can be used, then the resulting mixture of both oxygen and hydrogen can go through a bubbler to the flash suppressor 4 and into the engine. FIG. 1, numbers 27 shows a compressor pump which goes to 28 a containment cylinder, with then goes to 30 which is a value that meters the amount of compressed gas that is released into 25 the engine.

FIG. 1). shows a system that produces electrolytic fission that has been adapted to partially fuel and boost a fossil fuel based engine.

The apparatus can be made in any shape or size for any motor application using the coil or plate based system used to build the reactors. The system draws its energy from a standard car battery 18 and is actuated by a series of switches and relays 12 and 13. The unit also uses a fuse 17. The reactor unit 1, can be used with a diode 23 and specially designed ferrite coils 10 and 8. The system can also be used stock (running off the battery) or with a Pulse Width Modulator unit 14. The system then either separates the gases with 3 or can be provided with a safety bubbler to replace the separation apparatus \number 3 with a simple bubbler and a flash suppressor 4. Before going into the engine 25, the separated gas can also be pumped down with a pump 27, to a reserve cylinder number 28 and injected into the motor 25 with number 30 a metering valve.

FIG. 2, shows a two layer box fuel cell layout. The cell is grounded through its mounting to the car through 5. The two positive contacts are denoted by 7 and 8. This cell also has a check valve using a pump 3. The pump is 4, and the cell has two layers separated by a semi porous barrier 9. The body of the cell is 1, and the gas outlet is 2. FIG. 3, Shows a coil designed cell. The body of the cell is 1, this cell can be made up of a multitude of materials. This cell has a rubber cap 2, the coil is shown as 3, electrical contacts can be seen as 4 and 5. This figure shows a 10 plate cell that has 5 positive plates and 5 negative plates that alternate. The alternating plates are connected with each other with a shared junction point. These junctions are on two of the alternating corners of the plates. The plates are connected with threaded heat resistant material that holds the plates together at two centrally located holes. The plates are also connected at each alternating corners at positive and negative. The plates are separated by heat resistant insulator, non-conductive (electrical) spacers. The 10 plate cell is held in place in the containment vessel by two posts, (−) and (+), that are also used as the electrical contacts. The electrical contacts are then mounted via stainless steel or brass hardware to the bottom of the vessel through its material. If stainless steel is used, insulated contacts must be utilized. If the material is polymer the contacts (+) and (−) can go right through the material of the vessel with out insulators. The posts are used to bind the plate arrays both (+) and (−) to the vessel and also act as a physical electrical contact. If 10 cells are not desired Neutral plates can be placed be placed between the middle and outer charged, plates to tune the cell. Neutral plates are not attached to either (+) or (−) electrical contacts.

### REFERENCE NUMBERS OF FIGURES

FIG. 1) 1 Fuel Cell Apparatus
2 Out let port Anti-Splash Mechanism
3 Fuel Separator
4 Flash Back Supressor
5 Positive Electo Coil
6 Negative Electro Coil
7 Bubbler Inlet
8 Resonant Coil 1
9 Resonant Coil System (2) with Diode
10 Resonant Coil 2
11 Pump Connection to Fuel Cell
12 Relay 1
13 Relay 2
14 Pulse Width Modulator
15 Amp Guage
16 Power Junction Block
17 Resetable Fuse
18 Battery
19 Fuse Block
20 Alternator
21 Air Pump leading to Reactor Cell
22 Earth Body Ground
23 Mono Directional Diode
24 Earth Grounds
25 Engine
26 Volt Gauge
27 Air Pump
28 Bubbler
30 Anti Flash Back Mechanism/Metering Valve

### GENERAL DESCRIPTION OF INVENTION

In operation both of these types of Hydrogen Producing Plate systems (Alternating Plate, and Coil) can be produced in varying sizes both plate height and width or length in case of the coil. Both use Stainless steel contacts and a polymer or non-conductive material to separate the plate arrays. Across the gap that is established is the electrical synapse where an electrical field is established and the current jumps here like a switch on and off like nano-discharge electrical strikes that form Hydrogen and Oxygen gas from Water containing a buffer solution to establish a current flow. The buffer strength (Molar Concentration or Ionic Strength) can be varied to fine tune the cell. The cell can be charge with either raw current of pulse width modulated current this current can also be transformed into high voltage electricity. Multiple coils and capacitors can be used to charge the buffer immersed elements. When the Hydrogen and Oxygen is produced it is them pushed through the bubbler that is the first safety mechanism to transfer the on demand produced hydrogen derived from water. The bubbler then goes through a flash suppressor which is the second safety mechanism in the fuel line from the hydrogen fuel cell. If this is a booster cell that can also be used in diesel engines to scrub pollutants and to extend mileage ranges, or in an Internal Combustion Engine to either augment to extend fossil fuel mileage or the fuel (Hydrogen) can be separated and pumped down using a compressor pump to pump down the hydrogen into a cylinder or dryer canister to fuel a compressed gas carburetor like those manufactured by IMPCO Manufacturing company. The compressed hydrogen fuel is then atomized into the intake to fuel the engine. The fuel delivery mechanism will also be able to jet a small amount of fuel (hydrogen) to maintain an engine idle. Due to hydrogen's increased flammability the more hydrogen that is introduced into the engine is linearly proportional to the adjustment that must be made in the vehicles timing of spark. Standard vehicles are set at a timing spark initiation of a few degrees left of top dead center of an engines operation in its four or two stroke cycle. The more hydrogen that is used (introduced) in to the engine as fuel, the more right of top dead center the ignition timing adjustment needs to be moved. This adjustment can be adjusted either mechanically or through the use of a timing circuit on newer vehicle models.

The Hydrogen fuel cell, once scaled will produce enough gas to idle a small engine at this time with the larger coil or plate system element.

We anticipate a few of the coils or plate cells can fuel a small engine if the hydrogen is vacuumed off and then vaporized into the intake through a vaporizer unit. To run on pure hydrogen gas the engine needs to be leaned out and an MAP sensor and the Oxygen sensor needs to be adjusted with an EFIE electrical unit. The timing of the spark of the ignition system also needs to be adjusted over top dead center of the ignition system due to hydrogen's higher flammability then gasoline. With a simple magnet system Hydrogen and Oxygen gasses can be separated, so the hydrogen will be stored in a pure form and the oxygen can then be released into the atmosphere, or re-introduced into the engine for another use.

1) A system that utilizes components that increase surface area and hydrogen reactivity by using a coil system or integrated plate system, both of these systems (coil and alternating plate) allow the electrical plates to increase surface area by using plate arrays with enhanced cross sanded surfaces, whether linear or coiled. The thickness of the plates and height and width can be varied to meet any OEM manufacturing requirement for a hydrogen producing element of these types. This type of system allows for smaller packaging of the fuel cell with equivalent or increased efficiencies.

2) An integrated system that increases gas mileage or energy usage of fossil fuel by providing a catalytic effect to fossil fuel. Even adding a minimal amount of Hydrogen Gas into the intake of an engine aids in more full combustion of fossil fuel in any traditional fossil fuel burning engine that has no waste spark. Hydrogen burns much hotter and faster than traditional fossil fuels and adds a catalytic effect for a more fuller combustion of fuel, thus emissions are less toxic, and more reacted.

3) This system promotes in FIG. 1. a system that is integrated and can produce Hydrogen on demand using basic or advanced electronics used to tune each reactor vessel, providing management, feedback, separation, storage, and safety shut off over-ride features.
